(19) United States
(12) Patent Application Publication
(10) Pub. No.: US 2017/0360230 A1
(43) Pub. Date: Dec. 21, 2017

(54) SECURE HOLDER FOR CHILD DRINKING CUP

(71) Applicants: Joseph Wayne Kraft, College Station, TX (US); Caitlin Ann Giles, College Station, TX (US)

(72) Inventors: Joseph Wayne Kraft, College Station, TX (US); Caitlin Ann Giles, College Station, TX (US)

(21) Appl. No.: 15/629,706

(22) Filed: Jun. 21, 2017

Related U.S. Application Data
(60) Provisional application No. 62/352,681, filed on Jun. 21, 2016.

(51) Int. Cl. A47G 23/02; F16B 47/00; F16B 2/12; F16M 11/40; F16B 2/10

(52) U.S. Cl. CPC A47G 23/0225; F16M 11/40; F16B 2/10; F16B 2/12; F16B 47/00

(57) ABSTRACT

This device is designed to provide a secure mounted holder for a child's drinking cup. Most child cups are now designed to be spill proof but they are still often dropped or thrown by the child off of the high chair tray or table and onto the floor. This is very inconvenient and potentially dangerous. This device is designed to remedy that situation by creating a semi-rigid but flexible device to mount to the tray or table and attach to the child cup in such a manner to hold it up off the tray and be able to be bent over by the child enabling the child to take a drink. After drinking, the child can let go of the cup and the device with attached cup will return to its upright or semi-upright position thus avoiding spills and dropped cups.

### PRIORITY

This application claims priority from the disclosure of U.S. Provisional Patent Application No. 62/352,681, filed on 21 Jun. 2016, which is incorporated by reference herein.

### FIELD OF INVENTION

This device refers to the field of child care and child nutrition.

### BACKGROUND OF THE INVENTION

Any parent can attest to the fact that children tend to throw things down off of their high chair tray or table. This is done sometimes by accident and other times intentionally in order to prompt a predictable response by the caregiver. This problem has had several attempted remedies in the past but all have short comings. There are available tether based devices that can be tied to the cup to keep it from falling but then it makes it hard if not impossible for the child to retrieve it. This proposed device is designed to hold a drinking cup in a position that allows the child to access the cup at will, but will prevent the child from dropping or throwing the cup when they are not drinking. The device accomplishes this by connecting the cup to the tray or table using a semi flexible stalk. Ideally the cup would be mounted at a slight angle toward the child or be able to bend or hinge forward to enable the child easy access to drink from the cup. A semi flexible elastomeric stalk would span the distance between the two ends and provide easy bending toward the child for drinking and would also allow for the passive return of the stalk to a vertical position when released by the child. This would effectively allow the child to be able to access the contents of the cup without assistance and it would also prevent the cup from falling or being thrown to the floor.

### SUMMARY OF THE INVENTION

Spill proof cups are often chosen by parents to give to their children to help give the child some autonomy in choosing when to drink as well as making it less messy than a traditional open top cup. Most children transition through the stage of spill proof cups as a bridge between bottle/breast feeding and drinking from a traditional open top cup. These cups have truly revolutionized child care and child feeding techniques significantly over the years, but there still remains the extremely common problem of the child dropping or throwing the cup. This device is designed to make a spill proof cup much more useful and make child feeding much less stressful. A child's spill proof cup simply connects to an upper part of the device and a lower connection connects to a highchair tray or table. The exact mechanisms of these connections are different for the top connection and the bottom connection. The top connection (cup end) could consist of, but would not be limited to, a hook and loop fastener, an elastomeric fastener, a clamp, or even an attachment that is specific to lock into a mating surface on the specifically designed matched cup. The bottom (table end) connection could consist of, but is not limited to, a spring clamp, a screw clamp, a suction cup, or a tether. A connecting stalk that connects the upper end to the lower end ideally would consist of a relative thin section that is flexible but has intrinsic shape memory to return it to its near vertical position when not being pulled over by the child. The length of this stalk would be approximately 6-12 inches in length so as to provide enough flexibility to be pulled down to the child's mouth but also rigid enough to return to its original static vertical position when released.

Due to the fact that there is a wide range of child cup shapes and sizes, the cup connector end should be adaptable to multiple cup types or manufactured with a specific matching connectable cup. This proposed device reduces both the frustration for the child and the parent and would have clearly realized immediate intrinsic value to both.

This proposed device will also have the additional advantage of being able to be manufactured in many different colors, textures, styles and designs in order to cater to the decorating desires of the caregiver as well as appeal to the interests of the child.

### BRIEF DESCRIPTION OF THE DRAWINGS

Without restricting the full scope of this invention, the preferred form of this invention is illustrated in the following drawings:

FIG. 1 displays a drawing of a complete embodiment of the device utilizing a pivot type cup end attachment 5 and a suction cup type table end attachment 6;

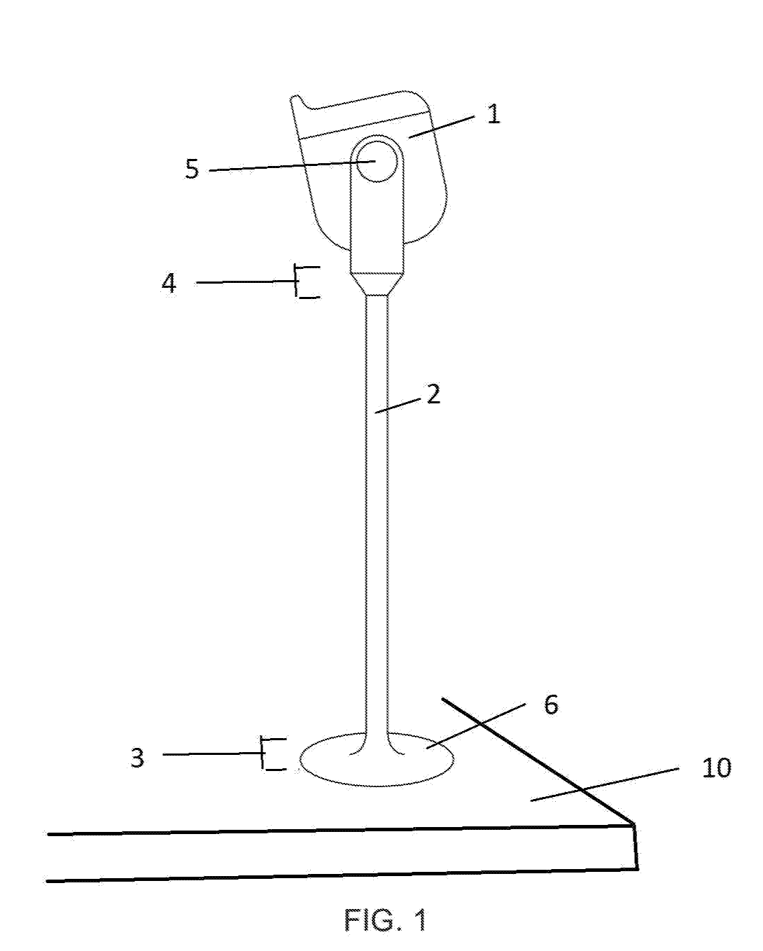

FIG. 2 shows a drawing of a complete embodiment utilizing a fixed type cup end connection 4 and a spring clamp table end connection 7; and

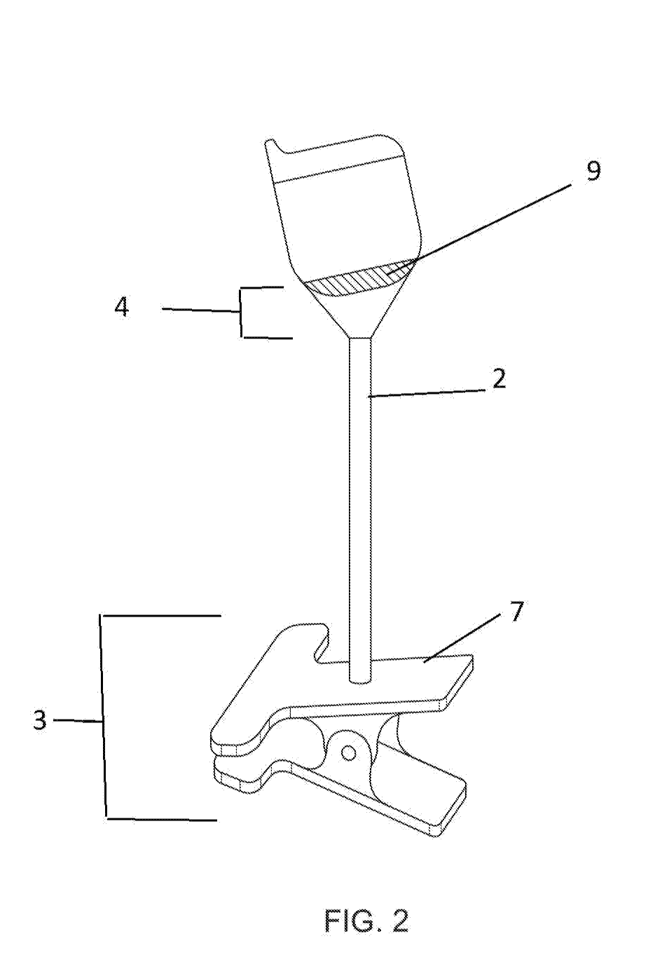

FIG. 3 shows a drawing of a partial embodiment demonstrating a possible screw clamp type of table end connection 8.

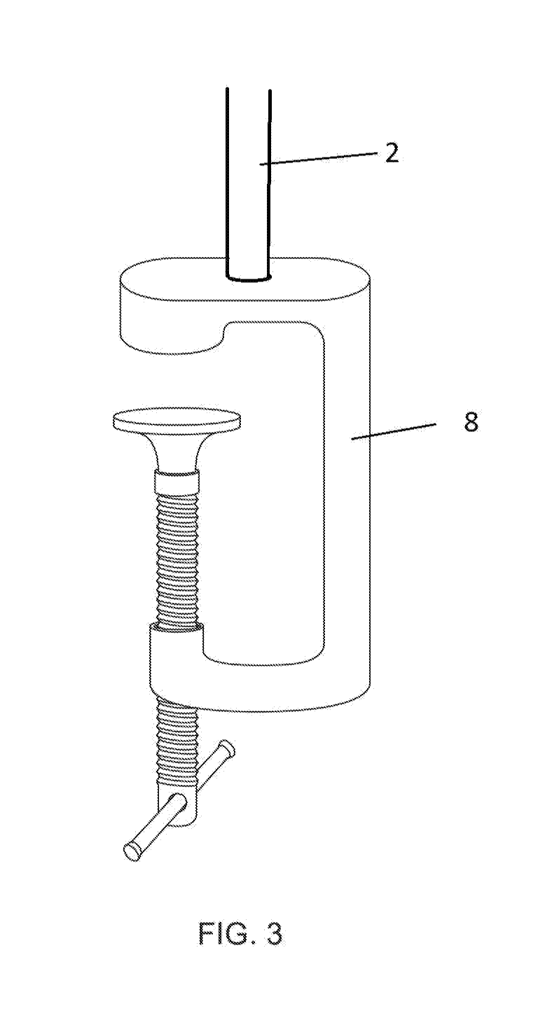

### DETAILED DESCRIPTION OF THE DEVICE

There are a number of significant design features and improvements incorporated within the invention.

The following description of certain embodiments of the invention should not be used to limit the scope of the invention. It is possible that other features, aspects, versions, and advantages of the invention may become apparent to those skilled in the art based on the following description. Accordingly, the descriptions and drawings should serve as illustrative in nature and not at all restrictive.

This proposed device is a simple method for connecting a spill proof child drinking cup 1 to a high chair tray or table 10 to prevent a child from dropping or throwing the cup 1 down but also to allow the child to be able to drink from the cup 1 easily. In order to do accomplish this simple task, this device has two connection ends which are located on either end of a semi-flexible stalk 2. One end is connected to the cup 1 and will be referred to as the cup end 4 and the other end is connected to a securing surface like a table or tray 10 and will be referred to as the table end 3.

The cup end of the device simply connects the stalk 2 to the cup 1 and must allow for some tipping of the cup 1 to facilitate drinking by the child. This can be done in many ways in different embodiments of the same device. One embodiment may use a hinge or pivot type connection 5 to allow for more tipping of the cup 1 while drinking. Other proposed connections could utilize mating connectors 9 on the cup 1 and stalk 2 end that can be used to lock the cup 1 into a fixed or hinged position. Other cup end connections 4 could be as simple as a hook and loop system.

The table end 3 of the device is used to connect the stalk 2 to the table or tray 10 and must be stable but removable. This connection could be, but is not limited to an embodiment utilizing a simple screw clamp 8 that can be tightened onto the table 10 and be out of the reach or capability of the child. Other embodiments could utilize a simple suction cup 6 that is strong enough to withstand the force that a small child is capable to putting on the device or a hook and loop fastener, an elastomeric fastener, or even an attachment that is specific to lock into a mating surface on the specifically designed matched cup.

The connecting stalk 2 is used to connect the cup end connector 4 and the table end connector 3 and could be, but is not limited to a thin semi-rigid but flexible stalk that would allow for the child to bend it over to drink out of the cup 1 and then be able to return to a near upright position when released. The length of this stalk would be approximately 6-12 inches in length so as to provide enough flexibility to be pulled down to the child's mouth but also rigid enough to return to its original static vertical position when released. Multiple different materials can be used to provide this function and should not be limited to any one specific material. In order to provide ideal function for this device it may also be helpful for the diameter of the stalk 2 to be narrower near the cup end in order to provide a more flexible location for bending so as to provide a better angle for drinking by the child.

The entire device should be made from materials that are child safe so as to not put the child at risk when exposed to this device.

Although the present invention has been described in considerable detail with reference to certain preferred versions thereof, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device comprising:
Having two connection ends located on either end of a semi-flexible stalk where one end is a cup end and the other end is a table end.

2. The device according to claim 1 further comprising:
where the cup end is connected to a cup.

3. The device according to claim 1 further comprising:
where the table end can be connected to a securing surface.

4. The device according to claim 3 further comprising:
Where the securing surface is a table.

5. The device according to claim 3 further comprising:
Where the securing surface is a tray.

6. The device according to claim 3 further comprising:
Where the table end is removable from the securing surface.

7. The device according to claim 6 further comprising:
Where the table end is secured using a screw clamp.

8. The device according to claim 6 further comprising:
Where the table end is secured using a suction cup.

9. The device according to claim 1 further comprising:
Where the connecting stalk is a thin semi-rigid but flexible stalk.

10. The device according to claim 1 further comprising:
Where the diameter of the stalk is narrower near the cup end.

11. The device according to claim 1 further comprising:
Where the cup end has a tipping means.

12. The device according to claim 11 further comprising:
Where the tipping means is a pivot connection.

13. The device according to claim 11 further comprising:
Where the tipping means is a locking means connection.

14. The device according to claim 11 further comprising:
Where the tipping means is a hook and loop system.

15. A device comprising:
Having two connection ends located on either end of a semi-flexible stalk where one end is a cup end and the other end is a table end, where the cup end is connected to a cup and where the table end is connected to a securing surface.

16. The device according to claim 15 further comprising:
Where the securing surface is a table.

17. The device according to claim 15 further comprising:
Where the securing surface is a tray.

18. The device according to claim 15 further comprising:
Where the table end is secured using a securing means.

19. The device according to claim 15 further comprising:
Where the connecting stalk is a thin semi-rigid but flexible stalk.

20. The device according to claim 1 further comprising:
Where the cup end has a tipping means.
